(19) United States
(12) Patent Application Publication
(10) Pub. No.: US 2004/0238031 A1
(43) Pub. Date: Dec. 2, 2004

(54) Heat actuated drain shutoff

(76) Inventor: Shane A. Lee, Ewa Beach, HI (US)

Correspondence Address: Richard C. Litman, LITMAN LAW OFFICES, LTD., P.O. Box 15035, Arlington, VA, 22215, US

(21) Appl. No.: 10/445,200

(22) Filed: May 27, 2003

(51) Int. Cl. F16K 17/38

(52) U.S. Cl. 137/74

(57) ABSTRACT

The heat actuated drain shutoff provides rapid actuation to stop the flow of a burning liquid into a drain system in order to prevent further damage to the drain system and structure in case of fire. The present shutoff includes a fusible element which melts when subjected to sufficient heat, thereby releasing a spring loaded valve to shut off flow through the drain. The spring actuation enables the device to be installed in any orientation, and the device is also adaptable to any environment having a drain for collecting flammable grease and liquids, such as kitchen or restaurant ventilation systems, service station islands, automotive repair shops, etc., where flammable liquids collected in a reservoir may be ignited.

### BACKGROUND OF THE INVENTION

1. Field of the Invention

The present invention relates to automated valves of various types, and more particularly to a shutoff valve in which the shutoff mechanism is actuated by heat melting a fusible element in the valve in order to release a spring which closes the valve. The present valve may be used in a number of different applications and environments, but is particularly useful in the restaurant and related industries for installation in kitchen ventilation systems. The present valve serves to close off the drain at the bottom of such ventilator duct systems, to preclude burning grease or the like from entering the grease trap in the event of a ventilator fire.

2. Description of the Related Art

Fires due to burning liquids are a potential hazard in many industries, including the restaurant and related industries. Such businesses and establishments are nearly universally equipped with some form of kitchen ventilation system, which draws heated air and cooking fumes from the cooking area, and which expels those gases to the exterior of the structure.

These systems generally utilize a relatively large, roof mounted fan to draw the air and cooking fumes from the cooking area of the kitchen, and employ a series of filters to capture grease and other vapors as they are drawn through the ductwork. Nevertheless, cooking grease and other foreign matter will condense and accumulate upon the interior surfaces of the ductwork, unless measures are taken to remove such deposits from time to time. Practically all jurisdictions have developed various rules relating to restaurant and food preparation sanitation, and require kitchen ventilator systems to be cleaned periodically. This is not only for the purpose of sanitation, but also to remove accumulated grease, which can be a fire hazard. In fact, it has been found that the majority of kitchen fires begin with cooking equipment which then flares into the ventilator system, and ignites deposits within the ventilator. A case in point is a fire which occurred in a restaurant in the terminal of Heathrow Airport, near London, in 1997. The fire advanced through contiguous ductwork from the restaurant, and required sixty firefighters almost five hours to contain.

Another hazard of such ventilator duct fires is the potential for the heated, liquefied burning grease to flow downwardly through the ventilator system and into the drains which lead to the grease trap for the system. If this occurs, the burning grease may easily ignite other grease deposits and/or heat air trapped within the system to the point that the system is ruptured or an explosion occurs.

While the danger and potential for destruction due to a ventilator fire are extremely high, the potential for disaster in the case of a fire or explosion within the grease trap and related drain system is perhaps even greater. The present inventor is aware of various devices which have been developed for the control, containment, and extinguishing of ventilator fires, at least one of which is addressed further below in the discussion of the specific related art. However, the present inventor is not aware of any device developed for controlling the spread of a burning liquid through a ventilator system, in order to prevent the burning liquid from flowing into the drain line and grease trap and causing further damage thereto.

Accordingly, a need will be seen for a device to prevent a fire from spreading to a grease drain or trap having a heat activated drain shutoff for installation in the drain system of a ventilation duct or other area as desired. The present shutoff valve includes a fusible element which melts when subjected to high temperatures, thereby allowing a spring to force a valve closed to preclude the flow of a burning liquid through or past the valve. The present shutoff valve is particularly valuable in the restaurant industry, but it will be seen that it is also of value in the petroleum industry and other fields in which flammable liquids may be encountered.

A discussion of the related art of which the present inventor is aware, and its differences and distinctions from the present invention, is provided below.

U.S. Pat. No. 2,118,299 issued on May 24, 1938 to Owen W. Ellis, titled “Bimetallic Sealing Device,” describes a number of embodiments of a bimetallic seal, or bimetallic spring for controlling a seal. The bimetallic element is exposed to the working fluid and expands or contracts according to its specific configuration, depending upon the fluid temperature. The bimetallic elements of the Ellis devices return to their original shape when the temperature returns to normal. In contrast, the present shutoff includes a fusible element (e.g. solder, etc.) which is unaffected by low temperatures but which melts at high temperatures to allow a compression spring to close the valve. The present shutoff device must be removed from its installation for resetting or replacement after actuation, which is desirable, as it requires inspection of the area surrounding the installation after a fire has actuated the present shutoff.

U.S. Pat. No. 2,777,303 issued on Jan. 15, 1957 to John P. Slattery, titled “Condensate Pump Drain Valve,” describes another bimetallic valve. The Slattery valve is adapted for use in heat pump installations, where condensate from the cooling side is splashed onto the condenser coils by the fan for additional evaporative cooling. If the condensate freezes, the ice locks up the fan, which can damage the system. The Slattery valve prevents this by opening in freezing temperatures to allow the condensate to drain, while closing in higher temperatures to retain the condensate. The Slattery valve thus operates opposite the present valve, and moreover must be reusable; it is not adaptable to the environment of the present shutoff valve.

U.S. Pat. No. 3,857,446 issued on Dec. 31, 1974 to Thomas M. Kenny, titled “Temperature-Sensitive Snap-Action Valve,” describes a mechanism utilizing over-center springs to produce a rapid opening or closing action in a valve, with the springs being operated by a proportional temperature control device. Kenny describes the use of a Vernatherm® valve to control the operation of the over-center springs and valve of his invention. The Vernatherm® valve utilizes an aneroid bellows principle, which slowly expands due to rising temperatures and contracts due to cooler temperatures. Such valves are commonly used to control oil flow through oil coolers in aircraft, and for other similar applications. Such a mechanism is unsuited for use in the present environment, where the valve may be subjected to intense heat and open flame.

U.S. Pat. No. 3,871,457 issued on Mar. 18, 1975 to William L. Livingston, titled “Fluid Control Device And A Fire Protection System Incorporating Said Device,” describes a discharge valve for fire extinguishing systems. The Livingston valve also utilizes a sealed aneroid to open the valve, somewhat like the Kenny mechanism discussed immediately above. The same points noted in that discussion, are seen to apply here as well.

U.S. Pat. No. 4,026,465 issued on May 31, 1977 to Thomas M. Kenny, titled “Temperature-Sensitive Snap-Action Valve,” is a divisional patent of the '446 U.S. Patent to the same inventor, discussed further above. The same points noted in that discussion, are seen to apply here as well.

U.S. Pat. No. 4,327,761 issued on May 4, 1982 to Russell S. Shelton, titled “Thermostatic Self-Powered Drain Valve,” describes a reversible valve actuated by a bimetallic element. The Shelton valve opens in colder temperatures and closes in warmer temperatures, and is used to drain water supplies to prevent pipe bursts in freezing temperatures. The Shelton valve is more closely related to the valve of the Slattery '303 U.S. Patent, discussed further above, than to the present invention.

U.S. Pat. No. 4,853,134 issued on Aug. 1, 1989 to Richard L. Cure et al., titled “Heat Sensitive Shut-Off Diverter Valve,” describes a reversible valve for controlling water flow through a water purifier. Such a valve must operate below the boiling point of water, and hence operates at a considerably lower temperature than the present shutoff valve. Cure et al. cannot use a fusible element to control their valve, as is done with the non-reversible, one-time operation of the present valve.

U.S. Pat. No. 5,127,425 issued on Jul. 7, 1992 to Kenneth R. Cornwall, titled “Horizontal Firestop Fitting,” describes a fitting installed in a tee extending above a horizontal pipe or conduit. The tee includes a plug installed therein, with the plug held in place within the tee by a plastic strap. When a fire occurs, the plastic strap melts and allows the plug to drop from the tee to block any flow through the conduit therebelow. While the Cornwall device is non-reversible, it operates according to gravity, and cannot be installed in any other orientation than that described. In contrast, the present shutoff valve is actuated by a spring which is held in compression by a fusible element. This permits the present device to be installed in any position desired, with the spring serving to push the valve closed in any direction or orientation.

U.S. Pat. No. 5,155,957 issued on Oct. 20, 1992 to Eric B. Robertson et al., titled “Fire Safety Device,” describes a section of conduit having a series of normally open flaps therein. An intumescent material is placed around the flaps, with the material expanding when high heat is applied. The intumescent material pushes the flaps closed to seal the conduit section. Robertson et al. do not use a fusible element which may be replaced in their conduit, as does the present drain shutoff invention.

U.S. Pat. No. 5,347,767 issued on Sep. 20, 1994 to Rudolf Roth, titled “Fire Retardant Sleeve,” describes a pipe sleeve or the like formed of a relatively soft material and surrounded by intumescent material. High heat causes the intumescent material to expand, thereby squeezing the pipe sleeve closed to shut off flow through the pipe. No axially moving poppet valve actuated by a compression spring released by the melting of fusible material is provided in the Roth sleeve. The Roth sleeve is more closely related to the device of the Robertson et al. '957 U.S. Patent, than to the present invention.

U.S. Pat. No. 5,429,116 issued on Jul. 4, 1995 to Stephen L. Brown, titled “Adjustable Ventilator,” describes a prefabricated ventilator system, a series of filters therefor, and a method of calculating the optimum filter size for optimum airflow. Brown also describes various means for adjusting a series of dampers for optimum airflow. One of the dampers is held open to a preselected position by one or more fusible elements, which release the spring-loaded damper to close in the event of a fire. However, this damper controls only airflow through the front of the hood, closing off airflow through a discharge port at the front of the hood to prevent flames from being drawn from the cooking unit upward through the discharge port and into the kitchen. The Brown device does nothing to prevent burning liquids from entering a drain line or grease trap, as it is situated on the forward side of the hood and the grease collection trough is situated along the lower edge of the back of the hood.

German Patent Publication No. 19,636,350 published on Apr. 17, 1997 to Schoettler Lunos Loeftung, titled “Fire Deterrent For Duct In Ventilation Pipe With Shut-Off Device,” describes (according to the English abstract) a bulkhead for blocking flame travel along a ventilation duct or pipe. The drawings illustrate several embodiments of closure flaps operating on the butterfly, side hinge, and pivot principles. All appear to utilize some form of bimetallic material to actuate the flap. The English abstract also notes the possible use of an expandable plastic material to actuate the flap, although such an embodiment is not illustrated. In any event, bimetallic or expandable plastic actuation of the flap would result in much too slow an operation to provide the rapid shutoff desired, and achieved by the present invention.

Finally, German Patent Publication No. 4,431,193 published on Oct. 1, 1998 to Bartholomaeus GMBH, titled “Fire Protector For Ventilation Duct Or Drain Pipe,” describes embodiments which are quite closely related to those of the '350 German Patent Publication discussed immediately above. The devices of the '193 German Patent Publication also use bimetallic or expanding plastic actuation, rather than the fusible element and spring of the present invention. The same problem with relatively slow actuation using such bimetallic or expandable materials noted in the discussion of the '350 German Patent Publication, also exists with the device of the '193 German Patent Publication.

None of the above inventions and patents, taken either singly or in combination, is seen to describe the instant invention as claimed. Thus a heat actuated drain shutoff solving the aforementioned problems is desired.

### SUMMARY OF THE INVENTION

The present invention comprises a heat actuated drain shutoff valve for rapidly shutting off the flow of a burning fluid from or in a duct or drain system. While the present invention may be adaptable to a number of different operating environments and applications, it is particularly well suited for installation in the drain of a commercial or restaurant kitchen ventilator system, where it serves to shut off any flow of burning grease in the event of a ventilator fire in order to prevent entry of the burning grease into the grease trap system.

The present valve is operable in any orientation, as the valve itself is actuated by spring compression when released by the melting of a fusible element. There is no need to position the present valve in any specific orientation. This provides great versatility for the present shutoff device, enabling it to be installed in a horizontal duct to shut off the flow of hot gases in a ventilator or other installation, if so desired. The present shutoff valve may also be installed in other operating environments, such as floor drain installations in automotive repair shops, gas station islands, and other such areas where flammable liquids may spill.

The present shutoff device includes a base having a drain opening at one end and a valve seat at the opposite end. A mounting flange extends outwardly from the base. A valve support comprising an open bracket attaches to the base mounting flange, or more accurately, to a mounting surface disposed between the base flange and the bracket. A poppet valve is suspended from the valve support bracket, and secured in an open position away from the valve seat by a fusible element (solder, etc.) securing the valve stem to the support bracket. A compression spring is installed on the valve stem between the head of the valve and the support bracket, and urges the valve toward the valve seat. When the fusible element is melted, the valve stem is released from its attachment to the bracket and the spring rapidly expands to push the valve against the seat, thereby shutting off flow past the valve and the base of the device to preclude flow of burning liquid (grease, etc.) into a grease trap or other drain system.

Accordingly, it is a principal object of the invention to provide a heat actuated drain shutoff which is particularly adaptable for installation in commercial and restaurant kitchen ventilator drain systems, in order to preclude flow of burning liquids from the ventilator into the grease trap system in the event of a fire.

It is another object of the invention to provide a drain shutoff valve which reacts rapidly to a fire or other sufficient source of heat, by melting a fusible element to release a valve stem and allow a compression spring to force a valve against a valve seat to close the shutoff.

It is a further object of the invention to provide a drain shutoff valve which does not reset automatically, but which must be reset by reinstalling the fusible element or which must be replaced after operation.

Still another object of the invention is to provide a drain shutoff valve which is easily installable in an existing ventilator duct system in any orientation as required, and which may also be installed in other operating environments as desired.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a detailed perspective view of a heat actuated drain shutoff according to the present invention, showing various details and features thereof.

FIG. 2 is a side elevation view in section of the present drain shutoff with the valve in the open position, showing further details thereof.

FIG. 3 is a side elevation view in section similar to that of FIG. 2, but showing the valve in the closed position after the fusible element has melted.

FIG. 4 is a schematic side elevation view in section of a typical commercial kitchen ventilator system, showing the installation of the present drain shutoff therein.

Similar reference characters denote corresponding features consistently throughout the attached drawings.

### DETAILED DESCRIPTION OF THE PREFERRED EMBODIMENTS

The present invention comprises two embodiments of a heat actuated drain shutoff, in which a valve is closed to shut off flow through the device when a fusible element melts due to excessive heat. The present shutoff device serves to prevent the flow of burning liquids (e.g. grease, fuels, etc.) from one area to another. The present invention may be installed in a number of different environments, but is particularly well suited for use in commercial and restaurant kitchen ventilator systems.

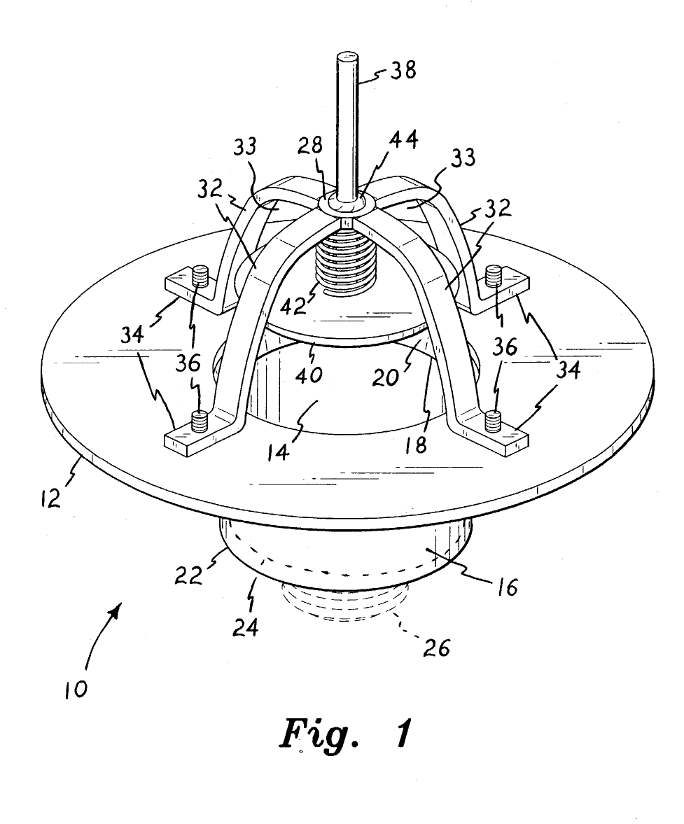

FIG. 1 provides an illustration of a first embodiment of the present heat actuated drain shutoff device, designated by the reference numeral 10. The shutoff device 10 generally comprises a valve assembly which is removably attachable to another structure, e.g. a drain surface 12 having a drain opening or passage 14 formed therethrough. Only a portion of the drain surface 12 is illustrated in FIG. 1, for clarity in the drawing. It will be understood that the drain surface 12 may comprise a portion of the ductwork in a ventilator system, a floor surface, or other drain apparatus. It should also be noted that as gravity is not required for actuation of the present valve assembly 10, it may be oriented in any direction required, e.g. as a gas or fluid flow shutoff valve in a horizontal air duct, etc. The horizontal orientation illustrated in the drawings is not required for operation of the present device 10.

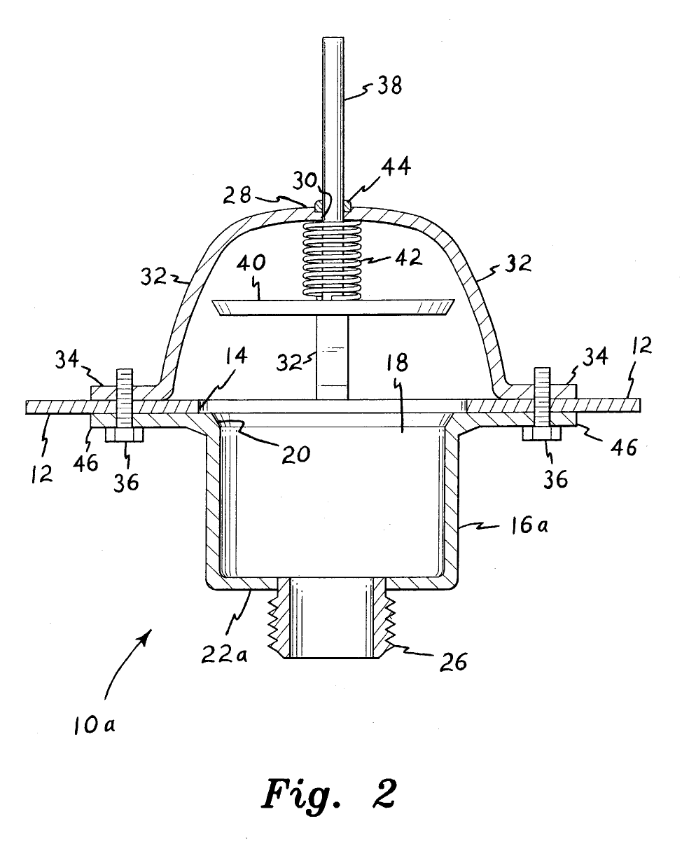

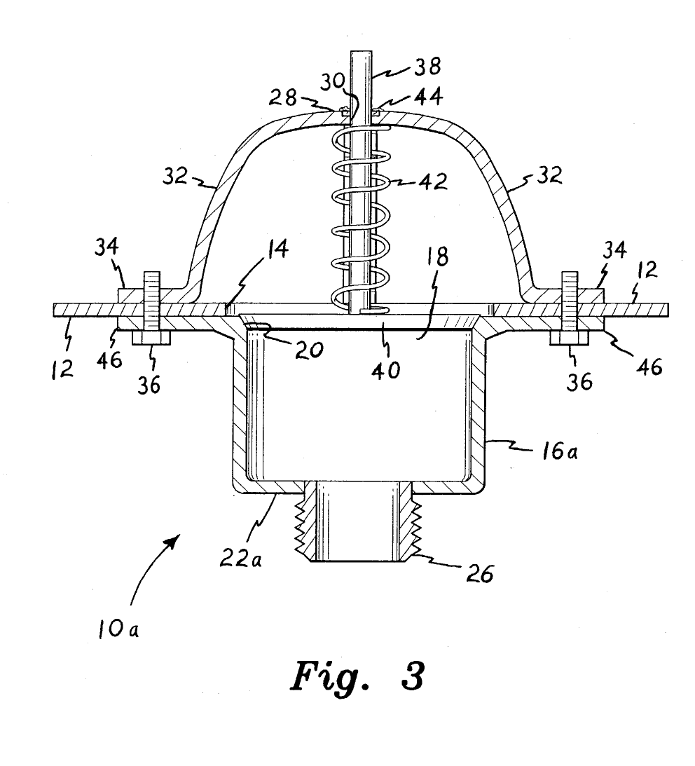

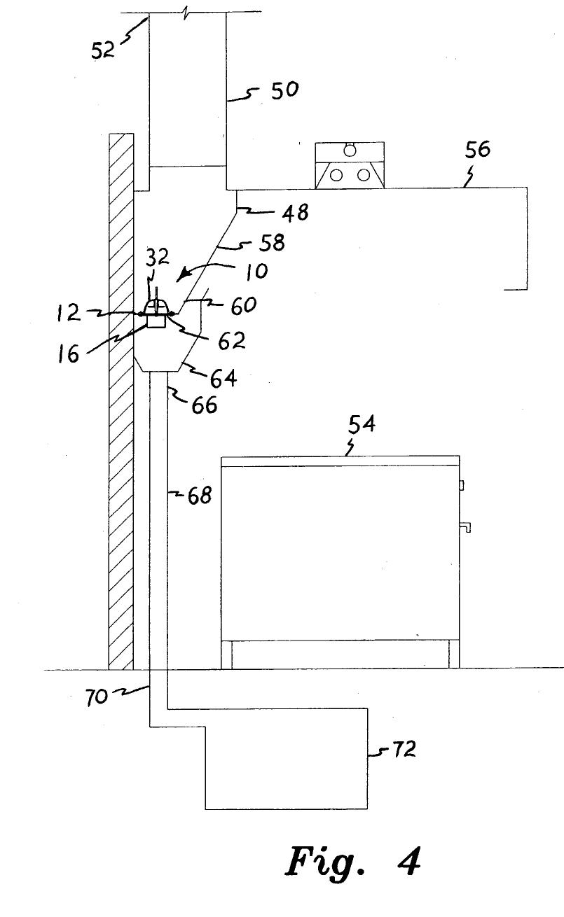

A base receptacle component 16 extends from one side of the drain surface mounting 12, with the base essentially comprising a cup-like container element having a continuous wall therearound. The base 16 has an open first end 18 with a valve seat 20, and an opposite second end 22 containing a drain fitting. The drain fitting may comprise an opening 24 extending at least partially, or perhaps completely, across the second end 22 of the base 16, as shown in the environmental installation view of FIG. 4, or may alternatively comprise a threaded or otherwise configured pipe nipple 26 of equal or smaller diameter extending from the second end 22 of the base 16, as shown in broken lines in FIG. 1 and in an alternative embodiment in FIGS. 2 and 3.

The portion of the assembly 10 opposite the base receptacle 16 includes a valve guide 28 having a valve stem passage 30 formed therethrough; the passage 30 is shown more clearly in FIGS. 2 and 3. The valve guide 28 is supported by a series of support arms 32, which extend radially from the valve guide 28 and secure to the drain surface 12 about the drain passage 14 by their distal base attachment ends 34 and a corresponding number of bolts 36, the ends of which may be seen in FIG. 1. Each of the support arms 32 is bowed outwardly away from the valve seat 20 of the first end 18 of the base receptacle component 16, to position the valve guide 28 axially away from the valve seat 20 of the base 16 for operating clearance for the valve of the present device, as explained further below. The support arms 32 define a corresponding number of fluid flow passages 33 therebetween, to allow fluid to flow between the arms 32, over the valve seat 20, and into and through the base receptacle 16 when the valve assembly 10 is open. It should be noted that while four arms 32 are shown, the specific number of arms is not critical, and may be more or fewer than those shown.

A poppet valve is installed in the valve support arm assembly, with the valve stem 38 passing through the valve stem passage 30 of the valve guide 28 and aligned axially with the base receptacle 16. A valve head 40 is disposed at the distal end of the valve stem 38, between the valve guide 28 and the valve seat 20 of the base receptacle 16. A coiled compression spring 42 is installed around the valve stem 38, and captured between the valve guide 28 and valve head 40.

The spring 42 urges the valve head 40 toward the valve seat 20, with the valve head 40 sealing against the valve seat 20 by means of the compressive force of the spring 42, unless the valve head 40 is held away from the seat 20 by some means. The present invention accomplishes this by means of a fusible material or element 44, which is applied about the valve stem 38 where it passes through the valve guide 28. This fusible material has a relatively low melting point, i.e. from a few hundred to perhaps several hundred degrees Fahrenheit, depending upon the alloy used. Thus, when the present valve assembly 10 is subjected to relatively high heat, as from a burning liquid, the fusible element 44 is melted, thereby releasing its restraint on the valve stem 38 and allowing the spring 42 to rapidly force the valve head 40 against the valve seat 20 to close off fluid flow through the base receptacle 16.

The fusible element 44 is preferably a solder of some sort, such as a conventional tin/lead alloy having a melting point of only a few hundred degrees. If it is desired that the present valve assembly 10 be capable of withstanding higher temperatures before valve closure, a higher temperature alloy, such as silver solder, may be used as the fusible element 44. For even higher temperatures, a copper alloy such as brass or bronze may be brazed in place about the valve stem 38 and valve seat 28. The specific metal percentages of these alloys may be adjusted or “tuned” to provide a melting point at a specific, predetermined temperature, thus causing the valve to close when that specific temperature is reached.

FIGS. 2 and 3 provide side elevation views in section of a heat actuated drain shutoff valve assembly 10a, with the valve shown in the open position in FIG. 2 and in the closed position in FIG. 3. The valve assembly 10a of FIGS. 2 and 3 is substantially identical to the valve assembly 10 of FIG. 1, with the exception of the pipe nipple drain fitting 26 extending from the base 16a. Other components are identical to those illustrated in FIG. 1 and discussed above, and are designated with identical reference numerals.

FIGS. 2 and 3 also show details of the attachment of the assembly 10 to the drain surface structure 12. In FIGS. 2 and 3, it will be noted that the base receptacle component 16a includes a flange 46 extending radially therefrom, for attaching the base 16a to the drain surface structure 12. The flange 46 is preferably coplanar with the valve seat 20 at the first edge 18 of the base 16a, in order for liquids to flow smoothly across the drain surface 12 and into the base receptacle 16a without having to pass over a protruding lip or edge. The attachment ends 34 of the valve support arms 32 are positioned to the opposite side of the drain surface 12, with the drain surface 12 being captured between the valve support arm ends 34 and the base receptacle flange 46. Bolts 36 pass through conventional bolt holes in the base receptacle flange 46 and drain surface 12, to thread into cooperating holes or passages in the valve support arm ends 34 to complete the assembly.

In FIG. 2, the shutoff valve assembly 10a is shown with the valve stem 38 secured in place in the valve guide 28, by the solid fusible element 44. The compressed coil spring 42 is retained between the valve guide 28 and the valve head 40, with the compressive force of the spring 42 providing a constant pressure urging the valve head 40 toward the valve seat 20. However, as the valve head 40 is held clear of the valve seat 20, fluid (e.g., wash or rinse water carrying grease, oil, etc.) is free to flow around the arms 32 through the fluid passages 33 therebetween, and into the base 16a where it is collected to drain through the pipe nipple drain fitting 26 for transfer and collection at some other point, e.g. grease trap and drain system, etc.

In the event of a fire or extreme heat in the area where the present shutoff valve 10 or 10a is installed, the heat melts the fusible material 44 which secures the valve stem 38 in its raised position, i.e. with the spring 42 fully or substantially compressed and the valve head 40 held well away from the valve seat 20. When the fusible element 44 is melted, the valve stem 38 is released, with the spring 42 rapidly forcing or pushing the valve head 40 against the valve seat 20 to shut off fluid flow beyond the fluid passage 14 of the drain surface 12. This precludes burning liquids from continuing to flow through the duct or drain system beyond the valve 40, and causing further potential damage to other areas of the structure.

The present shutoff valve 10 or 10a is a non-reversible valve, i.e., it does not automatically reset to its open position, nor can it be reset manually without removal and repair of the fusible element 44. This is desirable, for at least a few reasons. First, this construction is relatively inexpensive, enabling the present shutoff to be installed wherever it is needed at relatively little expense. Second, this construction is relatively maintenance free so long as the fusible element is not melted, and does not require any special periodic maintenance, battery replacement, adjustment, etc., as many other valves do. Third, in the event of a fire, it is desirable that the present valve be removed and checked in any case. The valve, and the associated ductwork or other environment, should be checked thoroughly for damage if a fire or sufficient heat is generated to operate the valve. The removal of the present valve to check the surrounding structure provides the opportunity to reopen the valve and secure the valve stem 38 with a fresh fusible element 44, thus readying the assembly for further use.

FIG. 4 provides a schematic elevation view in section of an exemplary installation for the present valve 10. While a shutoff assembly 10, with an open second end in its base receptacle 16, is illustrated in FIG. 4, it will be seen that the alternative embodiment shutoff valve assembly 10a, with its pipe nipple fitting 26, may be installed in lieu of the valve assembly 10, if so desired. Where the shutoff assembly 10a with its pipe nipple fitting 26 is used, a mating pipe, tube, hose, etc. may be attached to the fitting 26 for liquid drainage.

In FIG. 4, the present drain shutoff 10 is shown installed at the lower end 48 of the exhaust duct 50 in an exemplary ventilator system as may be installed in a restaurant or commercial kitchen or cooking area, for drawing cooking fumes, heat, etc. out of the cooking area. Typically, such systems are equipped with a relatively large roof mounted fan (not shown) at the upper end 52 thereof, which is not critical to the present invention. The exhaust duct 50 extends from its lower end 48 above and to the rear of the stove or cooking unit 54, with a range hood 56 or the like extending forwardly over the cooking unit. An inlet vent or screen 58 is generally provided toward the rear of the hood 56, at the lower end 48 of the duct 50.

Typically, grease and cooking residue vapors are drawn into the duct 50, where they are collected in various filters (not shown). However, some of this residue will condense and collect upon the relatively cool interior surfaces of the duct 50 and other areas within the vent system. Accordingly, virtually all jurisdictions have various regulations requiring such systems to be washed out and cleaned periodically. Practically all such systems have a collection receptacle 60 with a fluid passage 62 at the lower end of the duct 50, with a liquid collection sump 64 below and adjacent the lower duct collection area 60. The sump 64 connects to the upper end 66 of a drain line 68, with the opposite lower end 70 connecting to a grease trap 72. Residue flushed from the ventilator system, or liquid grease which runs through the system, is collected in the grease trap 72, which in turn connects to the conventional sanitary sewer system.

At times, sufficient heat can be generated in the system to ignite the flammable cooking grease residue which has collected within the duct 50 and related components. This is a typical cause of fires occurring in a commercial restaurant or cooking facility. When such fires occur, the heated and burning grease is liquefied, and runs downwardly through the system to the collection line 68 and can reach the grease trap 72. At this point, the potential exists for igniting other grease within the trap 72, and spreading the fire beneath the floor of the structure and perhaps to other structures connected by the sanitary sewage system.

The present invention prevents such an occurrence by rapidly closing the drain opening 62 in which it is installed, to prevent the flow of burning liquid grease from the collection receptacle 60 at the lower end 48 of the ventilator. duct 50. In the event of a ventilator fire, the fusible element 44 of the present heat activated drain shutoff 10 or 10a is melted, thereby releasing the valve stem 38 and causing the valve head 40 to close against the valve seat 20 and seal off the base 16 of the device with its open end 22a or drain passage 26. Any burning liquid residue is thus captured within the ventilator system, and cannot flow downwardly into the grease trap and associated drain system to spread the fire.

The present drain shutoff is easily installed within an existing ventilator system, simply by accessing the conventional drain opening 62 found in the collection area 60 at the lower end 48 of the ductwork 50. The shutoff is separated into its two major components, i.e. the base 16 (or 16a) and the valve support arms 32 with their attached valve assembly, and the valve assembly and support arms 32 are worked through the drain opening 62. Once the valve assembly and arms 32 are in position within the lower end of the ventilator plenum, the base component 16 (or 16a) is installed. The bolts 36 are passed through the preformed holes in the base 16 (or 16a) and in the bottom of the residue collection area at the bottom of the ductwork, and threaded into the ends 34 of the valve support arms 32 (or into threaded fasteners captured thereon) to complete the installation.

It will be noted that the compressive force of spring 42 provides a positive pressure maintaining the valve head 40 against the valve seat 20, thereby sealing the valve in the closed position so that the valve head 40 cannot become dislodged, e.g., by vapor pressure developing in the grease trap and drain.

In conclusion, the present heat activated drain shutoff provides a much needed safety device for precluding the spread of a fire from a ventilator system to the associated drain system. The present shutoff valve is relatively simple and inexpensive to manufacture and install, but is potentially worth many times over its manufacturing and installation costs in terms of the potential for reducing damage and destruction in the event of a fire in a ventilator system. While the present shutoff device has been shown in a vertical orientation, i.e. with its valve operating along a vertical axis, it should be noted that there is no restriction upon the orientation of the present shutoff when installed, as its actuation is independent of, gravitational forces. The compression spring used to close the valve of the present device when the fusible element melts, will serve to operate the valve closure regardless of the orientation of the device. Thus, the present shutoff valve may be installed in horizontal or other non-vertical ducts or drains, as well.

It should also be noted that the present heat activated shutoff valve may be installed in a floor drain or similar location or installation, wherever there is some potential hazard of flammable liquids flowing into the drain system. While the present valve will allow such liquids to flow into the system so long as they are not burning, in the event of a fire, the present shutoff will actuate to close the valve, thereby preventing the burning liquid from flowing into the drain system and spreading the fire or possibly causing an explosion. The present shutoff valve in its various embodiments is thus also well suited for installation in such areas as gasoline station ramps and areas near gasoline pumps, automotive service shop floors, and other areas where drain systems are provided and where the potential exists for flammable liquids to ignite. Accordingly, the present heat actuated shutoff device provides a solution for a long standing problem in many different operating environments where the flow of burning liquids into drainage systems has posed a safety hazard.

It is to be understood that the present invention is not limited to the embodiments described above, but encompasses any and all embodiments within the scope of the following claims.

I claim:

1. A heat actuated drain shutoff, comprising:
a base having a first end and a second end opposite the first end;
a valve seat disposed in the first end of said base;
a drain fitting disposed through the second end of said base;
a mounting flange extending radially from the first end of said base;
a valve guide having a valve stem passage formed therethrough, said valve guide having a plurality of support arms extending therefrom, each of said support arms defining a plurality of fluid passages therebetween and having a distal base attachment end;
a valve stem disposed in said valve stem passage;
a valve head attached to said valve stem, and disposed between the valve stem passage and said valve seat;
a fusible element disposed about said valve stem at said valve guide, securing said valve stem in place and holding said valve head clear of said valve seat; and
a compression spring disposed about said valve stem between said valve guide and said valve head, said rapidly forcing said valve head against said valve seat when said fusible element is melted.

2. The heat actuated drain shutoff according to claim 1, wherein said drain fitting of said base comprises a threaded pipe nipple extending from said base.

3. The heat actuated drain shutoff according to claim 1, wherein said drain fitting of said base comprises an opening extending across said base.

4. The heat actuated drain shutoff according to claim 1, wherein each of said support arms is bowed away from said valve seat, said valve guide being spaced axially from said valve seat.

5. The heat actuated drain shutoff according to claim 1, wherein said mounting flange is substantially coplanar with said valve seat.

6. The heat actuated drain shutoff according to claim 1, further including a plurality of bolts securing said support arms to said mounting flange.

7. The heat actuated drain shutoff according to claim 1, wherein said fusible element is selected from the group consisting of tin/lead solder, silver solder, and copper alloy solder.

8. The heat actuated drain shutoff according to claim 1, wherein said compression spring comprises a coil spring.

9. A heat actuated drain shutoff, ventilator, and ventilator drain system, comprising in combination:
a valve assembly, comprising:
a base having a first end and a second end opposite the first end;
a valve seat disposed in the first end of said base;
a drain fitting disposed through the second end of said base;
a mounting flange extending radially from the first end of said base;
a valve guide having a valve stem passage formed therethrough, said valve guide having a plurality of support arms extending therefrom, each of said support arms defining a plurality of fluid passages therebetween and having a distal base attachment end;
a valve stem disposed through said valve stem passage;
a valve head attached to said valve stem, and disposed between said valve guide and said valve seat;
a fusible element disposed about said valve stem at said valve guide, securing said valve stem in place and holding said valve head clear of said valve seat; and
a compression spring disposed about said valve stem between said valve guide and said valve head, said spring rapidly forcing said valve head against said valve seat to close said valve when said fusible element is melted;
a ventilator and drain system, comprising:
a duct having an upper end and a lower end opposite the upper end;
a collection receptacle having a fluid passage formed therethrough disposed at the lower end of said duct;
a drain line having an upper end adjacent said collection receptacle, and an opposite lower end; and
a grease trap communicating with the lower end of said drain line;
wherein said valve assembly is installed in the fluid passage of said collection receptacle, said valve assembly shutting off fluid flow through the fluid passage when said fusible element is melted and said valve head is forced against said valve seat in order to close said valve assembly and preclude fluid flow through said valve assembly and said drain line to said grease trap.

10. The heat actuated drain shutoff, ventilator, and ventilator drain system combination according to claim 9, wherein said drain fitting comprises a threaded pipe nipple extending from said base.

11. The heat actuated drain shutoff, ventilator, and ventilator drain system combination according to claim 9, wherein said drain fitting comprises an opening extending across said base.

12. The heat actuated drain shutoff, ventilator, and ventilator drain system combination according to claim 9, wherein each of said support arms is bowed away from said valve seat, valve guide being spaced axially from said valve seat.

13. The heat actuated drain shutoff, ventilator, and ventilator drain system combination according to claim 9, wherein said mounting flange is substantially coplanar with said valve seat.

14. The heat actuated drain shutoff, ventilator, and ventilator drain system combination according to claim 9, further including a plurality of bolts securing said support arms to said mounting flange.

15. The heat actuated drain shutoff, ventilator, and ventilator drain system combination according to claim 9, wherein said fusible element is selected from the group consisting of tin/lead solder, silver solder, and copper alloy solder.

16. The heat actuated drain shutoff, ventilator, and ventilator drain system combination according to claim 9, wherein said compression spring comprises a coil spring.
